(19) United States
(12) Patent Application Publication
(10) Pub. No.: US 2009/0119254 A1
(43) Pub. Date: May 7, 2009

(54) Storing Accessible Histories of Search Results Reordered to Reflect User Interest in the Search Results

(76) Inventors: Tiffany B. Cross, Pflugerville, TX (US); Lisa A. Seacat, San Francisco, CA (US); Cheryl M. Sedota, Cedar Park, TX (US)

Correspondence Address: IBM CORP (AP);C/O AMY PATTILLO, P. O. BOX 161327, AUSTIN, TX, 78716, US

(21) Appl. No.: 11/936,565

(22) Filed: Nov. 7, 2007

(51) Int. Cl. G06F 17/30

(52) U.S. Cl. 707/3; 707/E17.108

(57) ABSTRACT

Responsive to each user interaction of at least one user interaction with search results to separate network locations returned from a search request, the search results are reordered to reflect predicted user interest in the search results based on the user interactions. The reordered search results are stored. Responsive to a request for the stored reordered search results, the stored reordered search results are presented in a separate interface.

### CROSS-REFERENCE TO RELATED APPLICATIONS

The present application is related to co-pending application: (1) U.S. patent application Ser. No. ______ (Attorney Docket No. AUS920070551US1).

### BACKGROUND OF THE INVENTION

1. Field of the Invention

The present invention relates generally to an improved network search service and, in particular to an improved computer implemented method, system, and computer program product for recording user interactions with ordered search results and storing accessible histories of search results which are reordered to reflect user interest in the search results from the user interactions.

2. Description of the Related Art

With the vast amount of information available across systems connected to the Internet and other networks, services that search this information and provide lists of the information to users are more and more prevalent. These search services, also typically referred to as search engines, provide an interface for a user to enter one or more search terms for the search service to use in searching for the selection of information available across the Internet or other network of systems that matches the search terms. The search service identifies one or more websites or other data links with content that matches the search terms and returns a selectable list of the websites or other data links.

Even with a search result list of website and data links, a user still has the daunting task of searching through pages of search results and selecting websites or data links in the list to determine whether a particular website or data link presents relevant information that the user is hoping to find. To aid users in searching through search results, some search engines, before presenting a list of search results to a user, will perform analysis of the links in the list to calculate which of the links are most relevant to the search terms and to place the links with the greatest relevance at the top of the list.

As a user searches through search results to aid users in managing a history of searching through search results, some browsers will cache each link accessed by the user and adjust the color of the accessed links within the search results page to visually indicate to the user which links have been accessed. In addition, some search services, to aid users in managing a history of searching through search results will allow a user to store the results of a search query for future access.

Current search engine ordering techniques and search history storage are still limited in that once the search engine orders search results according to relevance to search terms or other criteria, the ordering is then fixed for that search list, even when stored, regardless of additional user interactions with the ordered search results.

### SUMMARY

Therefore, the present method, system, and program provide for recording user interactions with ordered search results and storing accessible histories of search results which are reordered to reflect user interest in the search results from the user interactions.

In one embodiment, a method, system and program product provide a history of previously generated search results ordered to reflect predicted user interest in the search results, responsive to each user interaction of at least one user interaction with search results to separate network locations returned from a search request, the search results are reordered to reflect predicted user interest in the search results based on the user interactions. The reordered search results are stored. Responsive to a request for the stored reordered search results, the stored reordered search results are presented in a separate interface.

In reordering the search results to reflect a predicted user interest in the search results, a first amount of time is tracked of at least one user interaction with a display interface displaying a first selection of the search results before the user selects to view a next selection of the search results. At least one first common content element in the first selection of the search results is detected. A second amount of time is tracked of at least one additional user interaction with the display interface displaying a second selection of the search results before the user selects to view a next selection of the search results. At least one second common content element in the first selection of the search results is detected. The predicted user interest is predicted in the at least one first common content element versus the at least one second common content element by comparing the first amount of time and the second amount of time.

In addition, in reordering the search results to reflect a predicted user interest in the search results, a first amount of time of a first user interaction with the search results and a first content element of at least one page accessed from the search results are detected. A second amount of time of a second user interaction with the search results and a second content element of at least one page accessed from the search results are detected. A search result reorganizer predicts greater user interest in one of the first content element and the second content element based on a comparison of the first amount of time and the second amount of time.

In storing the reordered search results, the reordered search results are stored in a database according to a search query term triggering the initial search query for the search results. The database includes multiple sets of reordered search results each stored according to separate search query terms. A selectable list of the search query terms for the stored sets of reordered search results is updated with the particular search query term for the newly stored reordered search results.

Responsive to a request for the stored reordered search results, the stored reordered search results are filtered to only present a selection of the stored reordered previously accessed through one of the user interactions with the search results before storage. In addition, responsive to a request for the stored reordered search results, at least one graphical attribute of the stored reordered search results is adjusted for presentation to reflect at least one characteristic of the previous user interactions with the search results.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting examples of components of a search result reorganizer in accordance with the method, system, and computer program of the present invention;

FIG. 2 is a block diagram illustrating one example of a network environment in which a search result reorganizer may be implemented;

FIG. 3 is a block diagram depicting one embodiment of a computer system in which the present invention may be implemented;

FIG. 4 is a block diagram illustrating examples of a process of dynamically predicting user interests based on current user interactions with search result links, reordering search result links based on updates to the predicted user interests, storing the reordered search result links, and providing search result reports for previously presented search results

FIG. 5 is a block diagram illustrating an example of the search result links for a particular search query reordered responsive to user interaction with the search result links and subsequently available to a user in a search history report;

FIG. 6 is a high level logic flowchart depicting a process and program product for triggering a search result reorganizer to manage reordering of search result links according to user interests predicted from user interactions with the search result links;

FIG. 7 is a high level logic flowchart depicting a process and program product for a search result reorganizer reordering search result links responsive to user interest predicted from current user interaction with the search result links;

FIG. 8 is a high level logic flowchart illustrating the deployment of the search result reorganizer process software;

FIG. 9 is a high level logic flowchart depicting a process and program product for managing storage of reordered search result links; and

FIG. 10 is a high level logic flowchart illustrating a process and program product for managing generation of search result history reports.

### DETAILED DESCRIPTION OF THE PREFERRED EMBODIMENT

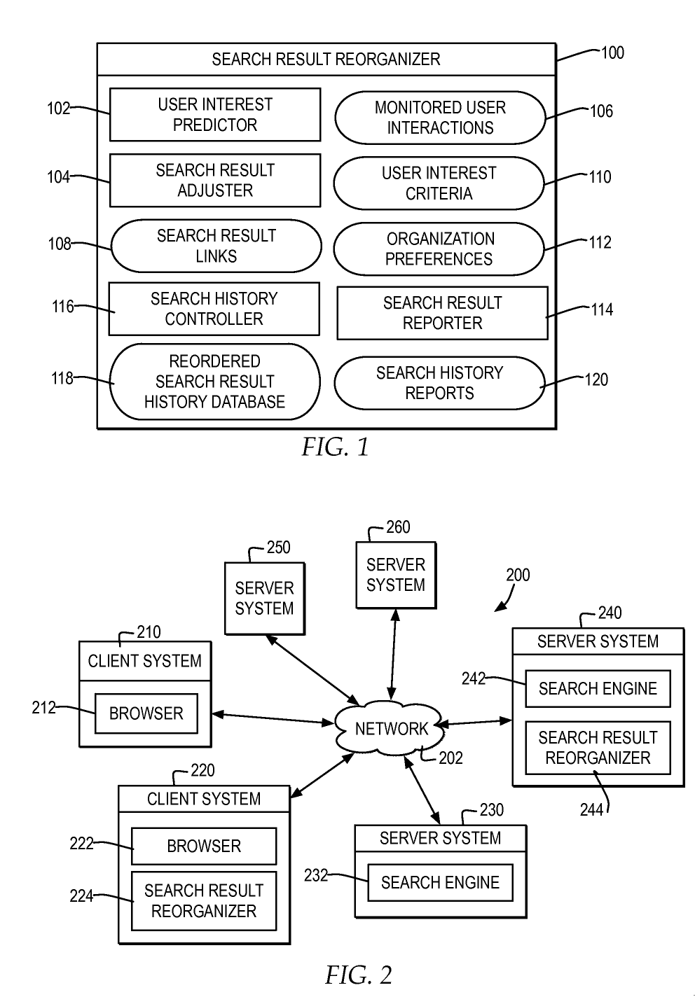

With reference now to the Figures, and in particular with reference now to FIG. 1, a block diagram illustrates examples of components of a search result reorganizer in accordance with the method, system, and computer program of the present invention. It is important to note that in additional or alternate embodiments, search result reorganizer 100 may include additional or alternate components and that the components of search result reorganizer 100 may function within a single computer system or be distributed among different systems across a network or among different logical systems.

In the embodiment, search result reorganizer 100 includes search result links 108 from a search engine or other type of network search service. Search result links 108 may include multiple types of links or other types of results for accessing multiple types of locations, including, but not limited to, network links for accessing a website or other network address and storage links for accessing data from a data storage system. In addition to a link address, each link may include a summary of contents of the web page accessible at the link address, a preview image of one or more downloadable images or other media available at the link, a link to previously cached images from the link, a percentage relevance to the search terms, and other information provided by a search engine or available from the tags, metadata or other data which describes the content of or data within the website or data accessible at a link address. Search result links 108 may include search results from one or more search engines accessed in one or more ways including, but not limited to, accessed directly from a search engine, accessed from a browser application receiving the search results, or accessed from a server system managing the search results. In addition, search result links 108 may include lists of links, individual links, and data structures including links, for example. Further, search result links 108 may include the indexing information accessed by a search engine in selecting search result links 108 for the search terms from among a database of multiple available links. Moreover, search result links 108 may be referred to herein as search results.

In addition, search result reorganizer 100 includes user interest predictor 102. User interest predictor 102 accesses any current user interaction with search result links 108 and stores current user interactions as monitored user interactions 106. In one example, user interest predictor 102 accesses user interaction with search result links 108 by detecting characteristics of user interactions with a display of search result links 108 within a browser application. User interactions included in monitored user interactions 106 may be cached only while a user accesses a browser window with search results or monitored user interactions 106 may be stored when detected and analyzed to detect patterns of user interaction across different sets of search results.

User interest predictor 102 analyzes each current user interaction with search result links 108 in view of the content of the links interacted with, and in view of user interactions previously stored in monitored user interactions 106 with the search results, to predict user interest in the search result links 108. In one example, user interest criteria 110 specify rules for analyzing user interactions and detecting the content of the links interacted with to determine levels of user interest in the search results. It is important to note that user interest criteria 110 may be specified according to at least one criteria including, but not limited to, a service providing search result reorganizer 100, a search engine providing search result links 108, or a user account for the user accessing search result links 108 at a browser.

User interest criteria 110 may specify one of multiple types and characteristic of user interaction for user interest predictor 102 to capture. For example, user interest criteria 110 may direct user interest predictor 102 to access current user interaction with search result links 108 indicating which link a user selects from search result links 108. In another example, user interest criteria 110 specify accessing user interaction with search result links 108 indicating how long a user spends looking at a web page accessed from a particular link in search result links 108. Further, user interest criteria 110 may specify accessing user interaction with search result links 108 indicating which items are selected within a web page accessed from a particular link in search result links 108, such as a downloaded item. Moreover, user interest criteria 110 may specify accessing user interaction with search result links 108 may indicating how long a user viewed a display of a portion of search result links 108 before requesting to view a next or previous portion of search result links 108.

In addition, user interest criteria may specify when to trigger user interest predictor 102 to detect content for a link in search result links 108. In one example, user interest criteria 110 may direct user interest predictor 102 to detect all of or the similar portions of the content of all links on a page including a portion of search result links 108 viewed by a user. In another example, user interest criteria 110 may direct user interest predictor 102 to only detect the content of links that a user selects to view from a display of search result links 108. In yet another example, user interest criteria 110 may direct user interest predictor to detect the content of links that a user positions a cursor, pointer or other selection device over for a particular amount of time.

In directing user interest predictor 102 to detect content for a link, user interest criteria 110 may designate detecting the content specified for the link in search result links 108 or may perform additional analysis or filtering to detect the content of the link. For example, user interest criteria 110 may direct user interest predictor 102 to search and identify the content of a website accessible from a link within search result links 108 when a user selects the link or separate from user selection of the link. In another example, user interest criteria 110 may direct user interest predictor 102 to search the tagging, metadata or header information of an accessed website or objects within the accessed website from a link in search result links 108 for content of the accessed website. In yet another example, user interest criteria 110 may direct user interest predictor 102 to determine content of links from the titles or descriptions of images or other media which is displayed, downloadable, or streamable from an accessed website from a link in search result links 108.

In addition, in directing user interest predictor 102 to detect content for a link, user interest criteria 110 may designate detecting particular types of content. For example, user interest criteria 110 may designate detecting redundant words in the content for a particular link or redundant words across the content of multiple links.

Further, user interaction criteria 110 may include instructions for user interest predictor 102 to narrow the content summary and descriptive terms for a website to those terms which relate to the at least one search term in the search query triggering search result links 108. In another example, user interaction criteria 110 may specify a database, including a dictionary, thesaurus, or other data system for indicating relationships of data content, to access for each search term to determine the types of content related to the search term which should be identified in the content summary and descriptive terms for a website.

Once user interest predictor 102 identifies a user interaction and detects content associated with the user interaction, user interest predictor 102 then predicts current user interests in search result links 108. In one example, user interest predictor 102 updates the content across the links most viewed by the user, with each user interaction, and predicts that a user is most interested in content associated with the longest user interactions. In addition, user interest predictor 102 predicts that a user is most interested in the redundant content of a particular website or multiple websites accessed from among search result links 108 that the user views for the longest period. Further, user interest predictor 102 predicts that a user is most interested in the types of content, such as media, that the user selects within a website from among search result links 108 based on each user interaction with the different types of content within a website. Moreover, user interest predictor 102 predicts that a user is not interested in redundant content among a selection of search result links 108 which are displayed, but skipped or minimally interacted with by the user.

A search result adjuster 104 within search result reorganizer 100 dynamically reorders search result links 108 from those links with content indicating most user interest to those links with content indicating least user interest, where user interest is determined by user interest predictor 102 from current and previous user interactions in monitored user interactions 106 and content of search result links with which a user interacts as applied to user interest criteria 110. In one example, for each user interaction detected by user interest predictor 102 and analyzed to detect user interests, search result adjuster 104 may reorder search result links 108 to reflect each respective change in user interests. In another example, organization preferences 112 specifies a number of links a user prefers to access from search result links 108 or an amount of time a user prefers to view a display of search result links 108 before search result adjuster 104 begins reordering search result links 108. One or more of a user, a website including a search engine interface, a browser, or a search engine may specify user organization preferences 112.

In particular in reordering search result links 108, search result adjuster 104 may determine, based on the content summary of unaccessed websites from among search result links 108, whether the unaccessed website links have the potential for greater user interest based on current user interest. In addition, in reordering search result links 108, search result adjuster 104 may reorder an accessed website for a link within search result links 108, but since the user has already accessed the link, the link is marked or graphically distinguished to indicate a previous access. An unaccessed website may include, but is not limited to, a website not accessed based on a current set of search results, a website not accessed within a particular period of time, and a website where an error occurred in attempting to access the website.

In another example, search result adjuster 104 dynamically reorders search result links 108 by determining additional search terms from the content of most interest in the user interests and sending the previously entered search terms by the user and the additional search terms to a search engine to request the search engine generate a new list of search result links. In one example, a search engine accessed by search result adjuster 104 may include an option allowing a user or search result adjuster 104 to enter additional terms to order previously accessed search result links. In another example, a search engine accessed by search result adjuster 104, in response to the additional search terms, may return a list of search result links which includes links in addition to the links previously accessed in search result links 108, but search result adjuster 104 may filter out the new links, add deleted links, or otherwise graphically distinguish new or deleted links within a display of the reordered search result links received from the search engine based on a search with the additional terms.

In one example, once search result links 108 are reordered, search result adjuster 104 may trigger the adjustment of the graphical display of at least a portion of search result links 108 within a browser interface or other graphical user interface displaying at least a portion of search result links 108. In another example, a user may view a sequence of links accessed in search result links 108, such as by viewing a slideshow of the links which advance one at a time in order, where search result adjuster 104 reorders search result links 108 underlying the sequence of links.

In addition, search result reorganizer 100 includes a search history controller 116. Search history controller 116 stores a history of generated search results, such as a history of search result links 108, in reordered search result history database 118. Reordered search result history database 118 includes one or more sets of previously generated search results for one or more search query terms. In particular, reordered search result history database 118 includes search results reordered to indicate those links with content indicating most user interest to those links with content indicating least user interest. In addition, reordered search result history database 118 includes previously generated search result links individually marked to indicate whether the user selected to view the specific search result link, whether the user viewed a display interface of search result links that included the specific search result link, and other information indicating user interaction with the search result link, such as monitored user interactions 106 or the predicted user interest by user interest predictor 102 applied in reordering the search result links.

In one example, search history controller 116 automatically monitors search result links 108 and stores search result links 108, as reordered by search result adjuster 104, in reordered search result history database 118. Search history controller 116 may be triggered to store search result links 108 periodically, responsive to each reordering, or responsive to opening or closing windows displaying search result links 108, for example. In another example, a user may trigger search history controller 116 or preferences set in organization preferences 112 may trigger search history controller 116 to store search result links 108 in reordered search result history database 118.

In another example, in a similar manner to search result adjuster 104 dynamically reordering search result links 108 based on user interest determined by user interest predictor 102, search history controller 116 may also dynamically reorder reordered search result history database 118 based on user interest determined by user interest predictor 102. User interest predictor 102 detects previous user interactions from monitored user interactions 106 and from at least one previous sets of monitored user interactions 106 stored with search result links 108 in reordered search result history database 118. In addition, user interest predictor 102 scans at least one set of search results stored in reordered search result history database 118 to detect the common content elements of each set of search results. Then, user interest predictor applies the previous monitored user interactions and the content with user interest criteria 110 to determine user interest for the at least one set of search result stored in reordered search result history database 118.

By determining user interest for one or more sets of search results from previously monitored user interactions, user interest predictor 102 may monitor additional patterns of user interest in content from different search queries and may monitor additional patterns of user interest in content from other service queries for a same set of search terms by other users. By user interest predictor 102 predicting user interest across multiple sets of search results in reordered search result history database 118, search history controller 116 may reorder one or more sets of search results in reordered search result history database 118 to reflect the predicted user interest of one or more users across multiple sets of search results.

Reordered search result history database 118 may store sets of previously generated search results according to the search query terms, according to date and time, or according to other criteria in one or more types of data storage structures. A search result reporter 114 manages generation of one or more search history reports 120 with all or a portion of the sets of search results within reordered search result history database 118 and manages access to and output of search history reports 120 to a user.

In particular, search result reporter 114 may apply additional filtering to search results within reordered search result history database 118 when generating search history reports 120 for a user. For example, in generating a search history report, search result reporter 114 may filter out any search result links from reordered search result history database 118 that were not previously accessed by the user. In another example, in filtering reordered search result history database 118 for a search history report, search result reporter 114 may move any search result links not previously accessed by the user to the end of the list of search results or may apply graphical attributes to distinguish those search result links previously accessed by the user from those search result links which were generated, but which the user did not select to access.

In addition, within search history reports 120, search result reporter 114 may apply additional graphical and audible attributes to the reordered selection of search results in a search history report to indicate additional information, such as distinguishing between different types of monitored user interaction with the search results by differing attributes. In another example, search result reporter 114 apply graphical or audible attributes to a search history report to distinguish particular portions of content within summaries associated with search results focused when user interest predictor 102 predicted user interest in the search results.

Search result reporter 114 may implement multiple types of interfaces through which a user may select to view all or sets of search results within reordered search result history database 118 through one or more search history reports 120. In one example, search result reporter 114 may provide a list of selectable report types based on search query terms, dates and times of previous searches, or other selectable terms for a user to select from for filtering the sets of search results within reordered search result history database 118 presented to the user. In addition, in the example, the list of selectable report types may be triggered in a pull down menu from a search term query interface or the list of selectable terms may be provided in a separate window. In yet another example, an interface support a user entry of search query terms and the user selection of a request to receive a history of the search query terms from reordered search result history database 118.

Responsive to a user selection of a particular selectable report type, such as selecting previous search query terms, search result reporter 114 may dynamically generate the report for a previous search query from reordered search result history database 118 for the user request. In dynamically generating the report for a previous search query, search result reporter 114 may also trigger search history controller 116 to dynamically update and reorder the search result for the previous search query. In another example, responsive to a user selection of a particular selectable report type, search result reporter 114 may access a previously generated search history report in search history reports 120 for the user request.

In addition, search result reporter 114 may support an interface in which a user may select to combine multiple previous search queries, where search result reporter 114 triggers search history controller 116 to dynamically reorder the search results for the multiple search queries based on user interest predicted by user interest predictor 102 for the particular set of previous search queries. In another example, search history controller 116 may detect a sequence of sets of search result links from search queries where a user has adjusted the search query terms to narrow or broaden a search, such as by removing or adding additional terms to previous search query terms. Search history controller 116 may automatically combine the search results for the sequence of related search queries into a single search query, reorder the combined search query results according to predicted user interest for the combined search query results, and provide a single search history report option for the combined search results.

In addition, search history reports 120 generated by search result reporter 114 may be searchable by a search service and presentable to other users. For example, where search result reorganizer 100 manages search history reports 120 for multiple users, a particular user may request to view the user interaction based reordered search result history for other users for particular search query terms. A search service may request that search result reporter 114 dynamically generate search history reports for the search query terms from other search results within reordered search result history 118 stored under the same search query terms or the search service may search through search history reports 120 for already generated reports for the same search query terms.

With reference now to FIG. 2, a block diagram depicts one example of a network environment in which a search result reorganizer may be implemented. It is important to note that network environment 200 is illustrative of one type of network environment which may support search engines, distribution of search results, search result reorganization, and search history reporting, however, client systems, server systems and other components of a system for supporting search services may be implemented in other network environments. In addition, it is important to note that the distribution of systems within network environment 200 is illustrative of a distribution of systems, however, other distributions of systems within a network environment may be implemented.

As illustrated, multiple systems within network environment 200 may be communicatively connected via network 202, which is the medium used to provide communications links between various devices and computer systems communicatively connected. Network 202 may include permanent connections such as wire or fiber optics cables and temporary connections made through telephone connections and wireless transmission connections, for example. Network 202 may represent one or more of packet-switching based networks and telephony based networks, local area and wire area networks, public and private networks.

Network 202 may implement one or more layers of one or more types of network protocol stacks which may include one or more of a physical layer, a link layer, a network layer, a transport layer, a presentation layer, and an application layer. For example, network 202 may implement one or more of the Transmission Control Protocol/Internet Protocol (TCP/IP) protocol stack or an Open Systems Interconnection (OSI) protocol stack. In addition, for example, network 202 may represent the worldwide collection of networks and gateways that use the TCP/IP suite of protocols to communicate with one another. In other examples, network 202 may implement one or more different types of protocol stacks and other types of protocol stacks.

Network environment 200 may implement multiple types of network architectures. In one example, network environment 200 may be implemented using a client/server architecture, where computing systems requesting data or processes are referred to as clients and computing systems processing data requests and processes are referred to as servers. In another example, network environment 200 may be implemented in a peer-to-peer network architecture. In yet another example, network environment 200 may be implemented in a grid architecture. It will be understood that other types of network architectures and combinations of network architectures may be implemented in network environment 200.

In the embodiment, as illustrated, one or more of client systems 210 and 220, server systems 230, 240, 250, and 260 are communicatively connected via network 202. Client systems 210 and 220 are representative of one or more client computing systems at which a user accesses a browser, application interface or network service, such as browsers 212 and 222, through which requests for data are sent to one or more of server systems 230, 240, 250, and 260 and through which data delivered from one or more of server systems 230, 240, 250, and 260 is output. In one example, server systems 230 and 240 represent server systems which include search engines, such as search engines 232 and 242, for searching web pages and other data available from one or more of server systems 230, 240, 250, and 260 which are relevant to a search query, including one or more search terms. It will be understood that server systems 230, 240, 250, and 260 are representative of one or more computing systems which may be searched, queried, accessed, and which may control delivery of data via network 202 and that additional or alternate systems may be accessible via network 202. In addition, it will be understood that each of client systems 210 and 220 may be implemented as a server for receiving requests for data and delivering data to other systems.

In one example, search engines 232 and 242 may maintain a database, such as an index, of links, contents, and other information about web pages available from one or more server systems, such as server systems 230, 240, 250, and 260, where the database of links is filtered for each search query to identify a selection of web pages with contents relevant to the search terms of a search query. In another example, search engines 232 and 242 may query other search services, search agents, or search engines with one or more of the search terms of a search query, where the other search services, search agents, or search engines filter through web pages and return a list of web pages with contents relevant to at least one of the search terms of the search query. Further, it will be understood that search engines 232 and 242 may implement additional or alternate methods of identifying a list of search results links relevant to a particular search query.

In one example, client system 210 includes a browser 212. Browser 212 interfaces with a website or other network location which includes an interface for search queries served by search engine 242. For example, browser 212 may interface with a website hosted by one of server systems 240, 250, and 260. When a user requests a search query for one or more search terms within the interface of the website, the website host passes, transmits, or communicates the search terms to search engine 242. Search engine 242 determines a selection of websites which are relevant to the search terms and returns search result links to the calling website for output within browser 212 or plugs in the compiled search result links within a particular portion of the website.

As a user interacts with the search result links returned within the website accessed by browser 212, search result reorganizer 244 monitors the user interactions with the search result links. In one example, the website host enables search result reorganizer 244 to monitor user interaction specifying the time between selections of links from the search result links or the amount of time a website selected from the search result links is accessed. In addition, search result reorganizer 244 may monitor additional types of user interaction with the search results links dependent upon indicators of user interaction indicated by browser 212 and the website host or search engine 242.

Based on the user interactions monitored by search result reorganizer 244 with search result links specified by search engine 242, search result reorganizer 244 determines user interests based on the user interactions with the search result links and detected content of the search result links. Based on the user interests determined from dynamic user interaction with the search result links, search result reorganizer 244 reorders the search result links specified by search engine 242. In one example, search result reorganizer 244 returns the reordered search result links to the website host, search engine 242, or browser 212. In addition, or alternatively, search result reorganizer 244 stores the reordered search result links within reordered search result history database 118 and enables an interface within browser 212 through which a user may select to view search history reports of reordered search results from previous search queries returned by search engine 242 or other search engines.

In another example, client system 220 includes a browser 222 and search result organizer 224. Browser 222 interfaces with a website or other network site which includes an interface for searching facilitated by a search engine, such as search engine 242 or a search engine 232. For example, browser 222 may interface with a website hosted by one or more of server systems 230, 240, 250, or 260. When a user requests a search query for one or more search terms within the interface of the website, the website host passes the search terms to a search engine.

In one example, where search result reorganizer 224 is fully operational from client system 220, the website host may access a search engine such as search engine 232. Search result reorganizer 224 detects the search result links received by browser 222 from search engine 232 and monitors user interactions with the search result links, including interaction with websites accessed from the search result links, within browser 222. In particular, for each user interaction or after a specified number of user interactions with the search result links, search result reorganizer 224 also detects the content of websites available from the search result links and analyzes the length of user interactions with content to determine user interests. In one example, search result reorganizer 224 detects the content of websites accessed from search result links by reading the tags, metadata or other data indicating the content of a website within the website document. Based on the determined user interests, in one example, search result reorganizer 224 reorders the currently accessed search result links. In one example, search result reorganizer 224 applies the reordering of the currently accessed search result links to the display of the search result links within browser 222.

In another example, where search result reorganizer 224 is a plug in or component of browser 222, including only a portion of the components described with reference to search result reorganizer 100, the website host of the website accessed within browser 222 may access a search engine such as search engine 242 which also implements search result reorganizer 244, including the additional portion of components described with reference to search result reorganizer 100 not performed by search result reorganizer 224. For example, search result reorganizer 224 may detect user selections of websites to access from the search result links and report the selections and length of selections to search result reorganizer 244, where search result reorganizer 244 then detects the content of the accessed websites, determines the user interest from the user interaction information reported by search result reorganizer 224 and the content detected by search result reorganizer 244, and reorders the search result links. In one example, search result reorganizer 244 sends the reordered search result links to search result reorganizer 224 for display within the website accessed within browser 222 or for search result reorganizer 224 to direct the website host of the website accessed within browser 222 to adjust the search result links to the reordered search result links.

Regardless of whether search result reorganizer 224 is a stand-alone application or a plug-in component that interfaces with search result reorganizer 244, search result reorganizer 224 stores any reordered search result links and monitored user interaction within reordered search result history database 118 in a storage system local to client system 220 or accessible at one of the other systems via network 202. In addition, search result reorganizer 224 provides a user interface separate from an interface for browser 222 or integrated within the user interface for browser 222 through which a user may select to view search history reports of reordered search result from previous search queries stored by search result reorganizer 224.

It is important to note that in addition to the distributions of search result reorganizer 100 described with reference to search result reorganizer 224 and search result reorganizer 244, search result reorganizer 100 may be distributed among additional or alternate systems in a network environment. In addition, search result reorganizer 100 may be distributed among multiple logical network partitions distributed within a single client system or server system or across multiple client systems and server systems. Further, multiple physical, logical or virtual instances of search result reorganizer 100 may be initiated at a client system or server system.

In particular, while it is understood that the process software of the search result reorganizer may be deployed by manual loading directly in client systems, such as search result reorganizer 224 of client system 220, directly in server systems, such as search result reorganizer 244 of server system 240, and proxy computer systems (not depicted) via loading a storage medium such as a CD, DVD, etc., the process software may also be automatically or semi-automatically deployed into a computer system by sending the process software to a server system or a group of server systems. The process software is then downloaded into the client computers that will execute the process software. Alternatively, the process software is sent directly to the client system or server system via email or other electronic communication. The process software is then either detached to a directory or loaded into a directory by button on the email or other electronic communication that executes a program that detaches the process software into a directory. Another alternative is to send the process software directly to a directory on the client system or server system hard drive. When there are any proxy servers, the process will select the proxy server code, determine on which computers to place the proxy servers' code, transmit the proxy server code, then install the proxy server code on the proxy computer. The process software will be transmitted to the proxy server, then stored on the proxy server.

In addition, in particular, while it is understood that the process software of the search result reorganizer may be deployed separately from a search engine, the process software may also be fully or partially integrated with or coexist with the search engine applications, search engine services, and operating systems on client systems and server systems in the network environment where the process software will function. Further, the process software of the search result reorganizer may be available as on demand on a shared server system.

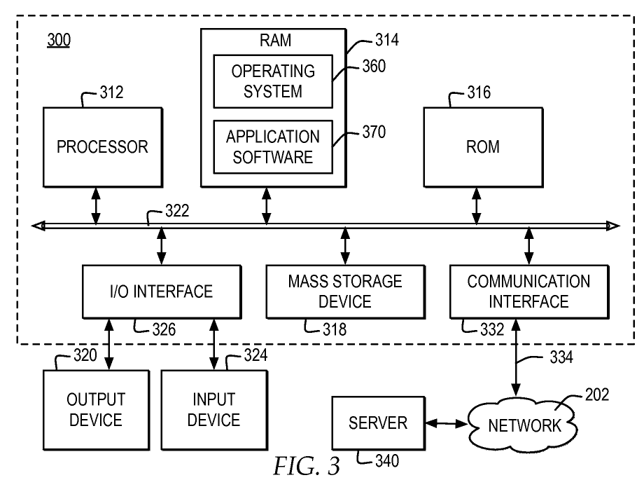

With reference now to FIG. 3, a block diagram illustrates one embodiment of a computer system or data processing system in which the present invention may be implemented. The processes, methods, computer program products, and systems of the present invention may be executed in a variety of systems, including a variety of computing systems, such as computer system 300, communicatively connected to a network, such as network 302.

Computer system 300 includes a bus 322 or other communication device for communicating information within computer system 300, and at least one processing device such as processor 312, coupled to bus 322 for processing information. Bus 322 includes low-latency and higher latency paths that are connected by bridges and adapters and controlled within computer system 300 by multiple bus controllers. When implemented as a server, computer system 300 may include multiple processors designed to improve network servicing power. Where multiple processors share bus 322, an additional controller (not depicted) for managing bus access and locks may be implemented.

Processor 312 may be a general-purpose processor such as IBM's PowerPC™ processor that, during normal operation, processes data under the control of an operating system 360, application software 370, middleware (not depicted), and other code accessible from a dynamic storage device such as random access memory (RAM) 314, a static storage device such as Read Only Memory (ROM) 316, a data storage device, such as mass storage device 318, or other data storage medium. Operating system 360, application software 370, or other layers of software may implement one or more of the components of search result reorganizer 100 described in FIG. 1.

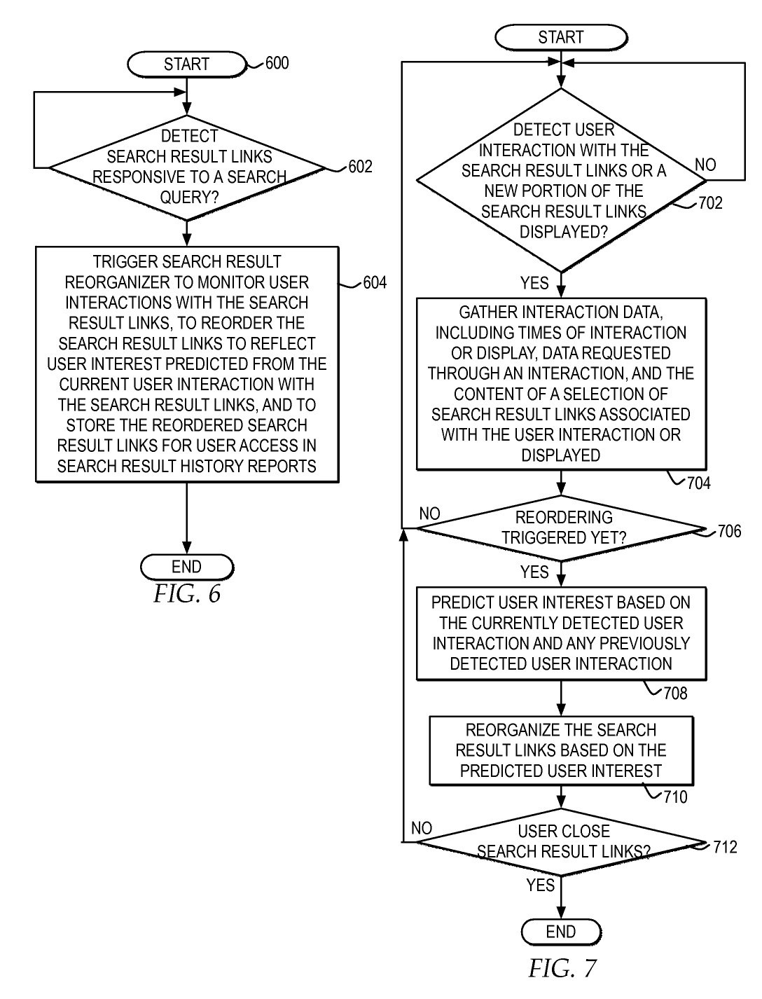

In one embodiment, the operations performed by processor 312 may control detecting search result links, predicting user interest in search result links based on current user interactions with the search result links, and dynamically reorganizing the search result links based on the current user interest, as described in the operations of the flowcharts of FIGS. 6-8 and other operations described herein. Operations performed by processor 312 may be requested by operating system 360, application software 370, middleware or other code or the steps of the present invention might be performed by specific hardware components that contain hardwired logic for performing the steps, or by any combination of programmed computer components and custom hardware components.

The present invention may be provided as a computer program product, included on a computer or machine-readable medium having stored thereon the executable instructions of a computer-readable program that when executed on computer system 300 cause computer system 300 to perform a process according to the present invention. The terms “computer-readable medium” or “machine-readable medium” as used herein includes any medium that participates in providing instructions to processor 312 or other components of computer system 300 for execution. Such a medium may take many forms including, but not limited to, storage type media, such as non-volatile media and volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 300 can read and which is suitable for storing instructions. In the present embodiment, an example of a non-volatile medium is mass storage device 318, which as depicted is an internal component of computer system 300, but will be understood to also be provided by an external device. Volatile media include dynamic memory such as RAM 314. Transmission media include coaxial cables, copper wire or fiber optics, including the wires that comprise bus 322. Transmission media can also take the form of acoustic or light waves, such as those generated during radio frequency or infrared data communications.

Moreover, the present invention may be downloaded or distributed as a computer program product, wherein the computer-readable program instructions may be transmitted from a remote computer such as a server 340 to requesting computer system 300 by way of data signals embodied in a carrier wave or other propagation medium via network 202 to a network link 334 (e.g. a modem or network connection) to a communications interface 332 coupled to bus 322. In one example, where processor 312 includes multiple processor elements, then a processing task distributed among the processor elements, whether locally or via a network, may represent a computer program product, where the processing task includes program instructions for performing a process or program instructions for accessing Java (Java is a registered trademark of Sun Microsystems, Inc.) objects or other executables for performing a process. Communications interface 332 provides a two-way data communications coupling to network link 334 that may be connected, for example, to a local area network (LAN), wide area network (WAN), or directly to an Internet Service Provider (ISP). In particular, network link 334 may provide wired and/or wireless network communications to one or more networks, such as network 202. Further, although not depicted, communication interface 332 may include software, such as device drivers, hardware, such as adapters, and other controllers that enable communication. When implemented as a server, computer system 300 may include multiple communication interfaces accessible via multiple peripheral component interconnect (PCI) bus bridges connected to an input/output controller, for example. In this manner, computer system 300 allows connections to multiple clients via multiple separate ports and each port may also support multiple connections to multiple clients.

Network link 334 and network 202 both use electrical, electromagnetic, or optical signals that carry digital data streams. The signals through the various networks and the signals on network link 334 and through communication interface 332, which carry the digital data to and from computer system 300, may be forms of carrier waves transporting the information.

In addition, computer system 300 may include multiple peripheral components that facilitate input and output. These peripheral components are connected to multiple controllers, adapters, and expansion slots, such as input/output (I/O) interface 326, coupled to one of the multiple levels of bus 322. Input device 324 may include, for example, a microphone, a video capture device, a body scanning system, a keyboard, a mouse, or other input peripheral device, communicatively enabled on bus 322 via I/O interface 326 controlling inputs. In addition, an output device 320 communicatively enabled on bus 322 via I/O interface 326 for controlling outputs may include, for example, one or more graphical display devices, audio speakers, and tactile detectable output interfaces, but may also include other output interfaces. In alternate embodiments of the present invention, additional or alternate input and output peripheral components may be added.

Those of ordinary skill in the art will appreciate that the hardware depicted in FIG. 3 may vary. Furthermore, those of ordinary skill in the art will appreciate that the depicted example is not meant to imply architectural limitations with respect to the present invention. For example, computer system 300 may also be a tablet computer, laptop computer, or telephone device.

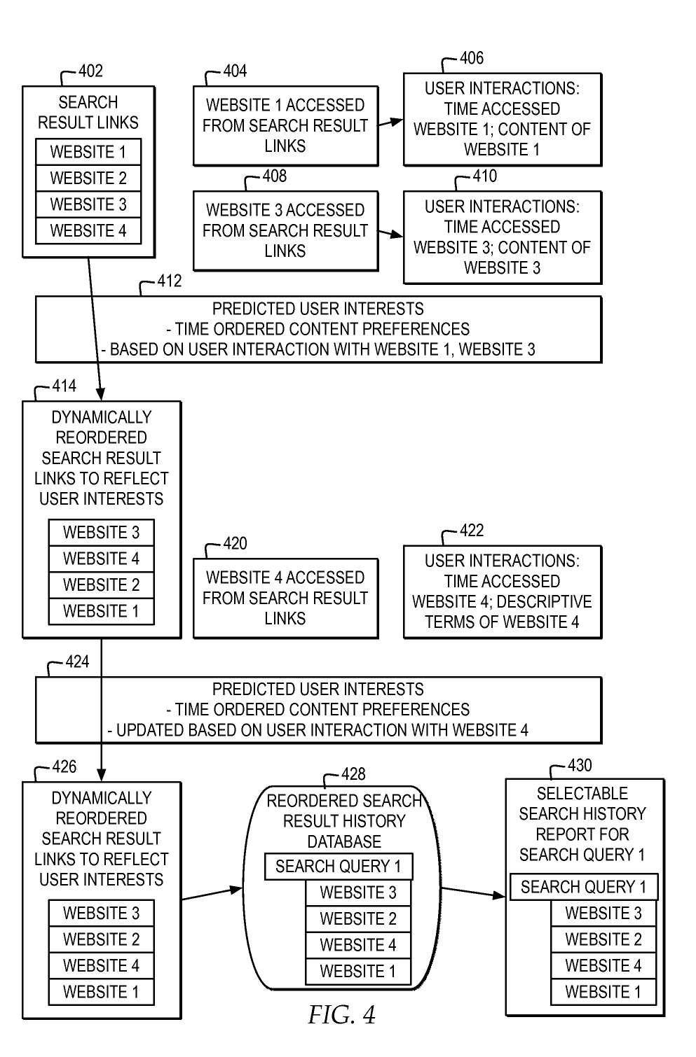

Referring now to FIG. 4, a block diagram illustrates examples of a process of dynamically predicting user interests based on current user interactions with search result links, reordering search result links based on updates to the predicted user interests, storing the reordered search result links, and providing search result reports for previously presented search results. The example is described with reference to data received by, detected by, processed by, and results returned by a search result reorganizer, such as previously described search result reorganizers 100, 224, or 244. In the example the search result reorganizer determines, detects, or receives search result links 402 for a search query. Search result links 402 include multiple links to websites that are relevant to at least one search term. Search result links 402 may be preordered by the search engine selecting search result links 402 for a search query according to factors such as relevance to the search terms for the search query or promotional interests, such as promoting those websites with which a search engine has a contractual relationship to promote.

A user may select to interact with at least a portion of search result links 402 displayed through a selectable list within a browser window. In particular, where only a portion of search result links 402 are displayed within the display area of a browser window, a user may select to interact with another portion of search result links 402 by selecting an arrow or other function that triggers accessing and displaying a next portion of search result links 402 within a browser window. In addition, a user may select to interact with search result links 402 by triggering a slideshow viewer or other type of viewer that automatically accesses and displays links from search result links 402 sequentially as triggered by a timer or user request to move to a next link.

In the example, the search result reorganizer monitors each user selection to access a website from search result links 402. For example, as illustrated at reference numeral 404, the search result reorganizer detects a “website 1” accessed from search result links 402, where “website 1” is listed as the first link in search result links 402. In addition, as illustrated at reference numeral 408, the search result reorganizer detects a “website 3” accessed from search result links 402, where “website 3” is listed as the third link in search result links 402. In one example, a user may select to view only a selection of the links in search result links 402 in an order selected by the user.

For each website accessed, the search result reorganizer detects user interactions with the accessed websites and the relevant content of accessed websites. As illustrated at reference numerals 406 and 410, the user interactions include the amount of time each website is accessed and the relevant content determined for the website. As previously noted, the relevant content of the website may include keywords identified in the tags or other metadata of a website, terms included in headings, outlines, or lists, in a website, terms used to name images within the website, and other types of content which identify the scope of the information accessible from the website as designated in the user interest criteria. Although not depicted, for each website not accessed, the search result reorganizer may also detect a lack of user interaction with one or more links and the relevant content of the unaccessed websites.

Based on the user interactions and relevant content illustrated at reference numerals 406 and 410, the search result reorganizer predicts user interests, as illustrated at reference numeral 412. The predicted user interests illustrated at reference numeral 412 may include, but are not limited to, a determination of the types of content preferred by the user in order according to the amount of time the user spends looking at the types of content. In additional or alternate examples, additional or alternate factors, including previously monitored user interactions and previously determined user interests may effect the current determination of user interests. Advantageously, however, even if previous user interactions and user interests are factors in predicting current user interests, the currently detected user interactions with a set of search result links dynamically effect user interests in search result links for a particular search query.

Based on the predicted user interests illustrated at reference numeral 412, the search result reorganizer dynamically reorders the search result links to reflect the currently predicted user interest, predicted from current user interactions, as illustrated at reference numeral 414. In the example, the predicted user interests illustrated at reference numeral 412 indicate that “website 3” is of most interest, with the ordering progressing to “website 1” of least interest. Although “website 2” and “website 4” are not yet accessed, these websites are ordered to reflect the predicted user interest in the content of these websites based on the content summary and other information accessed about these websites in view of the predicted user interests illustrated at reference numeral 412.

Next, as illustrated at reference numeral 420, a user interacts with the “website 4” from the dynamically reordered search result links illustrated at reference numeral 414. The search result reorganizer detects the user interactions with “website 4”, including a time accessing the website and the additional descriptive terms of the website, as illustrated at reference numeral 422. The search result reorganizer updates the predicted user interests, as illustrated at reference numeral 424, to reflect the user interaction with “website 4”. Based on the updates to the predicted user interests, as illustrated at reference numeral 424, the search result reorganizer dynamically reorders the search result links to reflect the updated user interests, as illustrated at reference numeral 426. In particular, in the example, the predicted user interests illustrated at reference numeral 424 indicate that “website 3” is still of most interest, with the ordering progressing to “website 1” of least interest, but the ordered positions of “website 2” and “website 4” are adjusted from the previous positions illustrated at reference numeral 414.

As illustrated, with each user interaction or following a series of user interactions or lack of user interaction, the search result reorganizer updates or predicts new user interests to indicate current user interactions with the search result links and then dynamically reorders the search result links according to the predicted user interests while the search result links are available for further user interaction. By updating the predicted user interests after each user interaction, the probability increases that with user interaction and reordering that the reordered search result links include links at the top of the preexisting search result links which are of most interest to the user and links at the bottom of the preexisting search result links that are of least interest to the user.

In the example, the search result reorganizer also stores the dynamically reordered search result links, as ordered at reference numeral 426, in the reordered search result history database, such as reordered search result history database 118, as illustrated at reference numeral 428. The reordered search result links are stored under a “search query 1” based on the search query terms, date and time, of the search query triggering search result links 402. Although not depicted, the reordered search result history database may include multiple sets of search results stored according to search query terms, date, time, and other criteria.

The search result reorganizer may store dynamically reordered search results at different points in time. In the example, the search result reorganizer stores the reordered search results after multiple reorderings of the search results. In another example, the search result reorganizer may store search result links 402 when initially accessed and then reorder the stored search result links to reflect user interests as a user interacts with search result links 402. In another example, the search result reorganizer may monitor user interactions and only when a user selects to close a window or store a window showing search result links, the search result reorganizer reorders the search result links to reflect user interests based on user interaction and search result reorganizer stores the reordered search result links.

In addition, in the example, the search result reorganizer enables a user to access a selectable report for “search query 1” from the reordered search result history as illustrated at reference numeral 430. In presenting the selectable search history report for “search query 1” as illustrated at reference numeral 430, the search result reorganizer provides a selectable listing of a user's previous search query from which the same user or a different user may return to access previously selected links or previously skipped links or from which a user may narrow or broaden search query terms. Because the user's previously accessed search results are also reordered to reflect the user interest predicted from the user's previous interactions with the search results, when the user accesses the selectable search result history report the user may quickly view the links that were predicted as most interesting to the user.

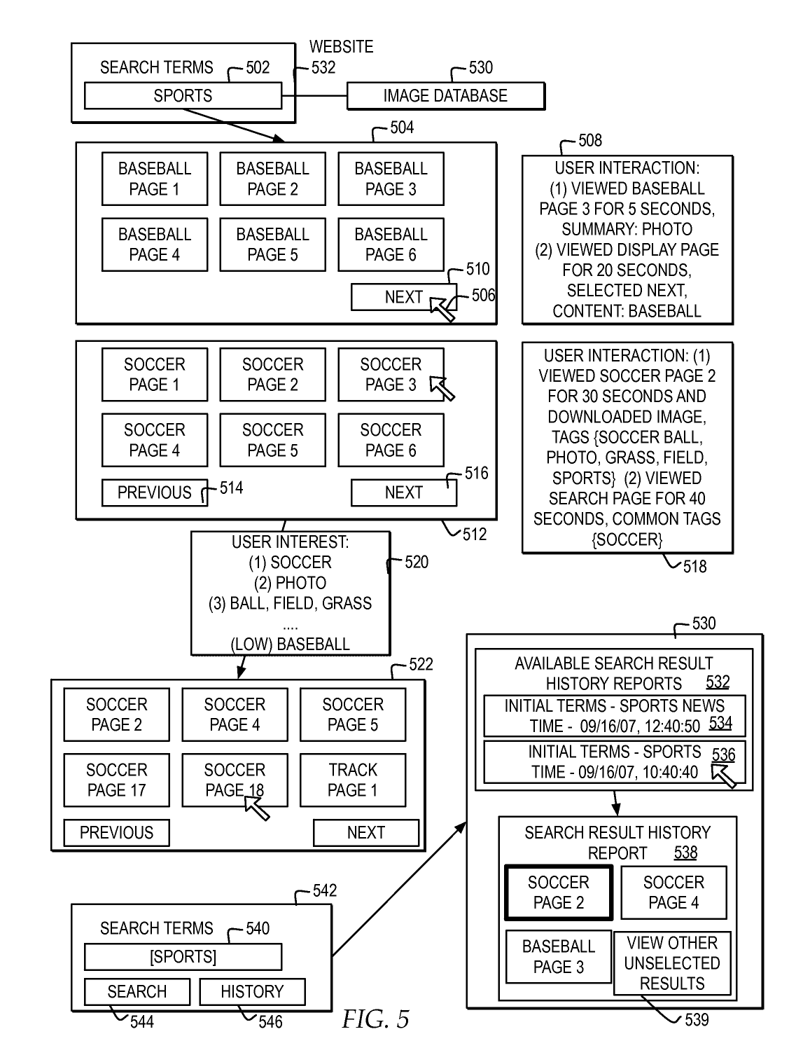

With reference now to FIG. 5, a block diagram illustrates an example of the search result links for a particular search query reordered responsive to user interaction with the search result links and subsequently available to a user in a search history report. In the example, a user accesses a website 532 with a search interface 502 into which a user may enter one or more search terms for a search query that searches an image database 530 according to entered search terms. In particular, in the example, a user enters a search term of “sports” for a search query of the images within image database 530 associated with sports.

A display window 504 includes a first portion of the search result links initially returned to website 532 relevant to the search term “sports”. As illustrated, display window 504 includes multiple links for images associated with baseball, which is relevant to a search query of “sports” depicted as “baseball page 1”, “baseball page 2”, “baseball page 3”, “baseball page 4”, “baseball page 5”, and “baseball page 6”. Although not depicted, each of the link references, such as “baseball page 1” may be represented by a reduced image of the full image, such as a thumbnail image, available at the link. In one example, if a user selects one of the links, such as selecting “baseball page 1” through positioning cursor 506 or entering other selection input, website 532 opens a new window or displays within display window 504 a webpage through which the user may view and download the particular baseball image from image database 530.

As illustrated at reference numeral 508, the search result reorganizer tracks user interaction within the portion of the search result links within display window 504. In the example, the user interaction depicted at reference numeral 508 includes user interactions with a particular link “baseball page 3” for a time period of “5 seconds” and the filtered content, from a summary for the link, of “photo”. In addition, in the example, the user interaction depicted at reference numeral 508 includes user interaction in general with an amount of time of “20 seconds” that display window 504 is accessed before the user selects to view a next portion of the search result links through selection of a next option 510 within display window 504. In addition, in the search result reorganizer monitoring an amount of time a portion of the search result links within display window 504 are open, the search result reorganizer may detect the common content among the portion of the search result links within display window 504, such as “baseball”.

In the example, the search result reorganizer organization preference is set for the search result reorganizer to wait to predict user interest and reorder the search result links until after a user has viewed portions of the search result links for a total of one minute. In another example, the search result reorganizer organization preference may be set to wait for the user to select a next option, such as next options 510 and 516, to view a next portion of search result links or to select a previous option, such as previous option 514, to view a previous portion of search result links.

In particular, in the example, when the user selects next option 510, 20 seconds have passed in the count of user interaction with the search result links and website 532 displays a next portion of the search result links as initially ordered by the search engine returning the search result links as illustrated in display window 512. Display window 512 includes multiple links for images associated with soccer which is relevant to a search query of “sports” depicted as “soccer page 1”, “soccer page 2”, “soccer page 3”, “soccer page 4”, “soccer page 5”, and “soccer page 6”. As previously noted, although not depicted, each of the link references, such as “soccer page 1” may be represented by a reduced image of the full image available at the link.

As depicted at reference numeral 518, the search result reorganizer tracks user interaction with the portion of the search result links within display window 512. In the example, the user interaction depicted at reference numeral 518 includes user interactions with a particular link “soccer page 2” for a time period of “30 seconds” with a detected user download of the image from the link and the content, from the tags of the downloaded image, of {soccer ball, photo, grass, field, sports}. A download is one example of a type of user interaction with the link that when detected by the search result reorganizer provides an indicator of user interest in a particular image. In addition, in the example, the user interaction depicted at reference numeral 508 includes user interaction in general with an amount of time of “40 seconds” that display window 512 is currently accessed and with the common tagged content among the links within display window 512 of “soccer”.

In the example, the search result reorganizer detects that the total amount of time viewing the search result links, from the user interaction illustrated at reference numeral 508 of 20 seconds and reference numeral 518 of 40 seconds, is one minute. In response to detecting that the condition in the organization preferences for reordering search results is set, the search result reorganizer first predicts user interests 520 based on the recorded user interaction illustrated at reference numerals 508 and 518. In the example, the search result reorganizer predicts, based on the amount of time that the user spent looking at a particular soccer image, the user downloading the image with a tags including “soccer ball” and the display window 512 open for the longest of any display windows with the common tag of “soccer”, that “soccer” is of most interest to the user, as illustrated in user interest 520. In addition, because the user selected “baseball page 3” and “soccer page 2” which both include the content of “photo”, the search result reorganizer predicts that a next interest of importance of the user is images which are photos as depicted in user interest 520. Further, because the downloaded image from “soccer page 2” also includes the tags of “ball”, “field”, “grass” and “sports”, the search result reorganizer predicts that the content of “ball”, “field” and “grass” are of importance to the user as illustrated in user interest 520, and discards the “sports” tag since this is the primary search term entered by the user. Moreover, with regard to the user interaction depicted at reference numerals 508 and 518, because the user only selected to view one image from the baseball images, quickly looked at the baseball image, did not download the image, quickly moved to a next portion of the search result links, and then downloaded a different image, the search result reorganizer predicts that baseball images are of low interest to the user.

As illustrated in display window 522, the search result reorganizer applies user interest 520 to the current ordering of the search result links and reorders the search result links to reflect user interest 520. In the example, display window 522 includes the search result links reordered to place those links predicted as most interesting to the user first, followed by links predicted to be of less interest. In the example, the search result organizer determines that the links of most interest to the user, in order, include “soccer page 2”, “soccer page 4”, “soccer page 5”, “soccer page 17”, “soccer page 18”, and “track page 1”.

“Soccer page 2”, “soccer page 4”, and “soccer page 5” were previously included in display window 522 and these pages include content which the search result reorganizer reorders to the top of the list of search result links in view of user interest 520. “Soccer page 2”, “soccer page 4”, and “soccer page 5” are examples of links previously viewed by a user, but ordered of high user interest according to user interest 520 in the reordered search result links.

“Soccer page 17” and “soccer page 18” were previously ordered lower in the search result links than “soccer page 6”. In particular, for purposes of illustration, each of the soccer pages were originally ordered in the search result links in numerical order. Without search result reorganizer reordering the search result links, “soccer page 17” and “soccer page 18” would have been accessible in a display window accessed following display window 512. The search result reorganizer determines that “soccer page 17” and “soccer page 18” are of greater interest to the user than soccer pages 7-16 based on the content of “soccer page 17” and “soccer page 18” rating higher in user interest 520 and search result reorganizer reorders “soccer page 17” and “soccer page 18” to a position following “soccer page 5”.

“Track page 1” was previously ordered lower in the search result links than all the soccer pages. In particular, for purposes of illustration, each of the track pages were originally ordered in the search result links following all the soccer links, such as a last soccer link page of “soccer page 20”. Without search result reorganizer reordering the search result links, “track page 1” would have been accessible in a display window following display window 512 and the display of all other soccer pages. According to an advantage, search result reorganizer determines that “track page 1” is of greater interest to the user than “soccer page 19” and “soccer page 20” based on the content of “track page 1” rating higher in user interest 520 and search result reorganizer reorders “track page 1” to a position following “soccer page 18”.

During or following the user interaction session illustrated within display windows 504, 512, and 522, the search result reorganizer stores the resulting reordered search result links in association with the search query term of “sports”. Through one or more interfaces, such as through a search interface 542, a user may enter a search query term and enter another input indicating the user request to view search history reports relevant to the search query term. In particular, in the example, by the user placing search query term 540 “sports” within parenthetical brackets “[” and “]”, the user indicates the preference to view search history reports relevant to the search term. In addition, in the example, the user may select between a search option 544 or a history option 546, where search option 544 triggers a search engine to perform a new search for search query term 540 and history option 546 triggers a search result reorganizer to provide available search result reports relevant to search query term 540. In other examples, search interface 542 may also include a pull down menu of previous search query terms or of search query terms for which search history reports are available.

It is important to note that the search history request service of search result reorganizer may plug into or be triggered through multiple different interfaces on a same client system. For example, in the example, a user performs a first search query within search interface 532, but requests a search result history report for the first search query through a separate search interface 542.

In the example, responsive to the user entry of search query term 540 with a request for relevant search history reports, the search result reorganizer displays a selectable interface 530 which includes available search result history reports 532 including reports 534 and 536 which are relevant to the search query term of “sports”. In particular, in the example, report 536 represents the history of the search results illustrated with reference to the search query term of “sports” illustrated through display windows 504, 512, and 522. Report 534 represents a history of the search result of a different search query term of “sports news” recorded after report 534. As illustrated in selectable interface 530, in addition to indicating the initial search query terms associated with a report, the date and time of the report recording is also included. In other examples, additional information, such as an identifier of the user who initially requested the search results may be provided. In addition, where there are multiple reports available for a particular search history report request, the search result reorganizer may order the reports according to particular criteria, such as date and time, or may order the reports according to reports with a greater predicted user interest.

In addition, in the example, the user selects to view report 536. In selecting to view report 536, search result reorganizer reports a selectable list of those search result links previously selected by the user when the user interacted with the search results. In particular, as illustrated within display window 504 and in recorded user interaction 508, the user selected to view the link for “baseball page 3” and within display window 512 and in recorded user interaction 518, the user selected to view the link for “soccer page 2” and “soccer page 4”. Thus, search result history report 538 includes “soccer page 2”, “soccer page 4” and “baseball page 3” ordered to reflect the predicted user interest in the search results from the user's previous interactions with the search results. In addition, as illustrated, the search result reorganizer may include an option 539 for a user to view the other, previously unselected search result links for the search query, as previously ordered to reflect predicted user interest. Further, search result reorganizer may further graphically distinguish the search result links presented in search result history report 538, as illustrated with respect to the visibly distinguishable graphical treatment of the link for “soccer page 2” to indicate the user previously downloaded an image from the link. It will be understood that the search result reorganizer may implement additional or alternate types of graphical or audible characteristics when generating a search result history report to graphically or audibly distinguish characteristics of previous user interaction with the search result links.

With reference now to FIG. 6, a high level logic flowchart depicts a process and program product for triggering a search result reorganizer to manage reordering of search result links according to user interests predicted from user interactions with the search result links. In the example, the process starts at block 600 and thereafter proceeds to block 602. Block 602 illustrates a determination by a browser application, a website host, a search engine service, or other monitoring entity communicatively connected to a network, whether search result links responsive to a search query are detected. When the monitoring entity detects search result links responsive to a search query, the process passes to block 604. Block 604 illustrates the monitoring entity triggering a search result reorganizer to monitor user interactions with the search result links, to reorder the search result links to reflect user interest predicted from the current user interaction with the search result links, and the process ends, and to store the reordered search result links for subsequent user access in search result history reports. In one example, a browser is the monitoring entity detecting search result links returned in a website displayed within the browser, which prompts the browser to triggers the search result reorganizer. In another example, a set of search result links includes a flag or other setting that when read by the monitoring entity of a browser or a website host receiving the search result links, directs the browser or website host to trigger the search result reorganizer. Further, in another example, a search engine returning search result links may also by the monitoring entity that triggers a search result reorganizer. Moreover, a server hosting a website that includes an interface for a user to enter a search query and receive search results, may perform as the monitoring entity that triggers a search result reorganizer. Further, it will be understood that additional or alternate entities may trigger search result reorganizer for a selection of search result links.

Referring now to FIG. 7, a high level logic flowchart depicts a process and program product for a search result reorganizer reordering search result links responsive to user interest predicted from current user interaction with the search result links. In the example, the process starts at block 700 and thereafter proceeds to block 702. Block 702 illustrates a determination whether a user interacts with the search result links or whether a new portion of the search result links displayed. If the user interacts with the search result links or a new portion of the search result links is displayed, then the process passes to block 704. Block 704 depicts gathering interaction data, including, but not limited to, times of interaction or display, data requested through an interaction, and the content of a selection of search result links associated with the user interaction or displayed.

Next, block 706 depicts a determination whether reordering of the search result links is triggered yet. In one example, search result reordering is triggered when a condition in the organization preferences is met. In another example, search result reordering may be specifically triggered by a search engine, by a website hosting an interface for a search engine, or by a user through a selectable option within a browser or website hosting an interface for a search engine to trigger reordering of the search result links. If reordering of search result links is not yet triggered, then the process returns to block 702. If reordering of search result links is triggered, then the process passes to block 708.

Block 708 illustrates predicting user interest based on the currently detected user interaction and any previously detected user interaction with the search result links. Next, block 710 depicts reorganizing the search result links based on the predicted user interest. Thereafter, block 712 illustrates a determination whether the user has closed the search result links. If the user is still accessing the search result links, then the process returns to block 702. If the user is no longer accessing the search result links, then the process passes to block 714. Block 714 depicts storing the reordered search result links in a reordered search result history database, and the process ends.

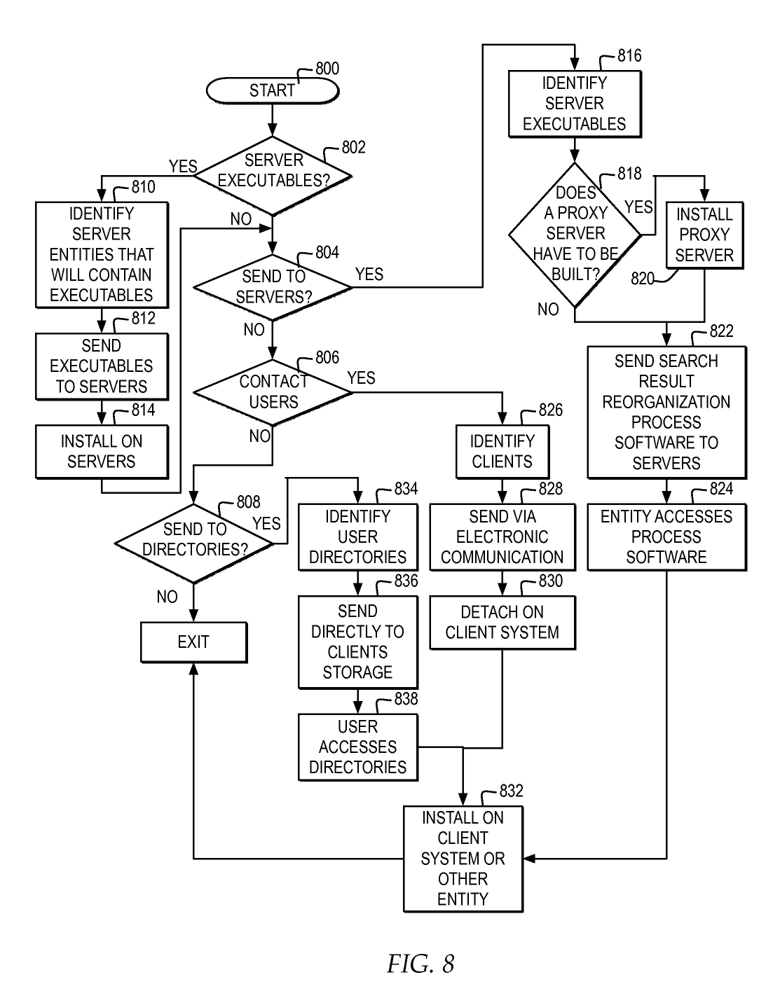

With reference now to FIG. 8, a high level logic flowchart depicts the deployment of the search result reorganizer process software. The first thing to determine is if there are any programs that will reside on a server or servers when the search result reorganizer process software is executed as illustrated in block 802. If this is the case, then the server entities that will contain the executables for the search result reorganizer process software are identified as depicted in block 810. The search result reorganizer process software for the server or servers is transferred directly to the server storage via file transfer protocol (FTP) or some other protocol or by copying through the use of a shared file system as illustrated in block 812. The search result reorganizer process software is then installed on the servers as depicted in block 814.

Next, a determination is made whether the search result reorganizer process software is to be deployed by having entities access the search result reorganizer process software on a server or servers as illustrated at block 804. If the entities to run the search result reorganizer process software are to access the process software on servers, then the server addresses that will store the search result reorganizer process software are identified as illustrated in block 816. Thereafter, a determination is made if a proxy server is to be built, as depicted in block 818 to store the search result reorganizer process software. A proxy server is a server that sits between a client application, such as a Web browser, and a physical server. The proxy server intercepts all requests to the physical server to see if the proxy server can fulfill the requests itself. If the proxy server cannot fulfill the requests to the physical server, then the proxy server forwards the request to the physical server. Two benefits of a proxy server are improving performance and filtering requests. If a proxy server is required, then the proxy server is installed, as depicted in block 820. The search result reorganizer process software is sent to the servers via file sharing as illustrated in block 822. Another embodiment would be to send a transaction to the servers that contained the search result reorganizer process software and have the server process the transaction, then receive and copy the process software to the server's file system. Once the search result reorganizer process software is stored at the server, the entities access the search result reorganizer process software on the servers and copy the search result reorganizer process software to their file system, as depicted in block 824. Another embodiment is to have the servers automatically copy the search result reorganizer process software to each entity and then the installation program for the search result reorganizer process software at each entity. The entity executes the program to install the search result reorganizer process software on the entity, such as a client system or other entity, and exits the process as depicted in block 832.

Otherwise, as to block 806, a determination is made whether the search result reorganizer process software is to be deployed by sending the search result reorganizer process software to entities via electronic communications. The set of entities where the search result reorganizer process software will be deployed are identified together with an electronic account address for each entity as illustrated in block 826. The search result reorganizer process software is sent via an electronic communication, such as an email, to each of the entity electronic account addresses as depicted in block 828. The entities receive the electronic communication sent to the entity electronic account address and detach the search result reorganizer process software from the communication to a directory on the entity as illustrated in block 830. The entity executes the program that installs the search result reorganizer process software on the entity, such as a client system or other entity, and then exits the process as depicted in block 832.

Further, otherwise, as to block 808, a determination is made whether the search result reorganizer process software will be sent directly to user directory on an entity, such as a user directory on a client system. If the search result reorganizer process software will be sent directly to the user directory of an entity, then the user directories are identified as illustrated in block 834. The search result reorganizer process software is transferred directly to the user directory as depicted in block 836. Transferring the search result reorganizer process software to the user directory can be done in several ways, such as, but not limited to, sharing of the file system directories and then copying from the sender's file system to the recipient user's file system or using a transfer protocol such as FTP. The users access the directories on their client file systems in preparation for installing the search result reorganizer process software as illustrated in block 838. The user executes the program that installs the search result reorganizer process software on the client system or other entity and then exits the process as depicted in block 832.

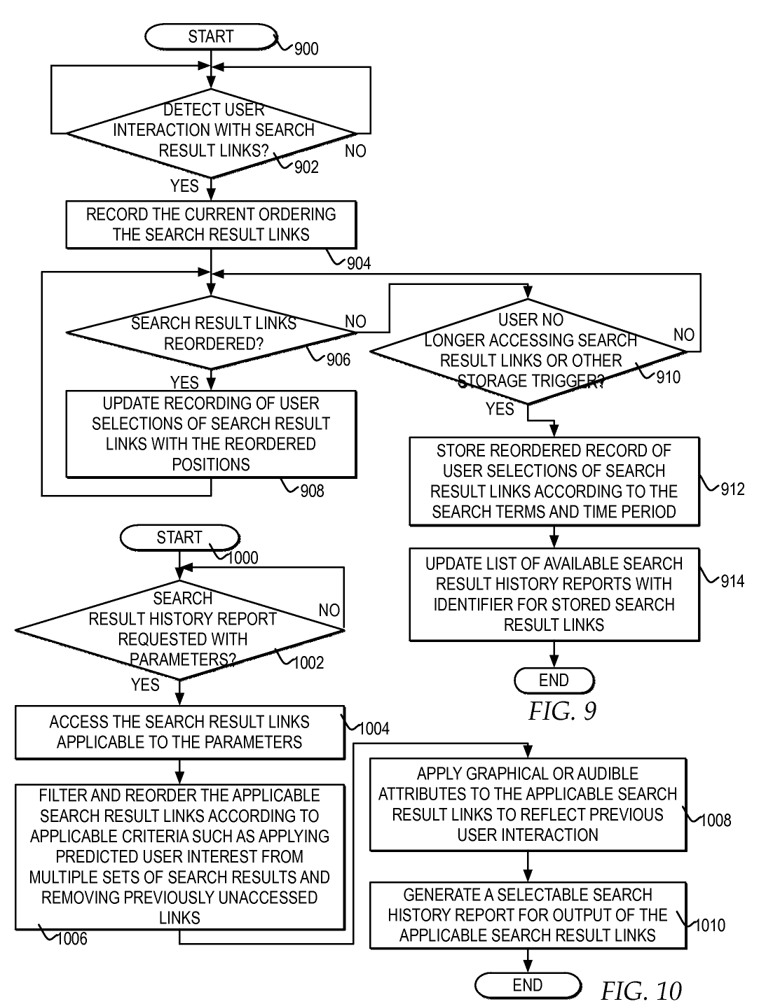

With reference now to FIG. 9, a high level logic flowchart depicts a process and program product for managing storage of reordered search result links. In the example, the process starts at block 900 and thereafter proceeds to block 902. Block 902 illustrates a determination whether the search result reorganizer detects user interaction with search result links. If the search result reorganizer detects user interaction with search result links, then the process passes to block 904. Block 904 depicts recording the current ordering of the search result links. Next, block 906 illustrates a determination whether the search result links are reordered. If the search result links are reordered, then the process passes to block 908. Block 908 illustrates updating the recording of the user selections of search result links with the reordered positions, and the process returns to block 906. At block 906, if search result links are not reordered, the process passes to block 910. Block 910 illustrates a determination whether the user is no longer accessing the search result links, such as by entering a new search query, closing the search results window, or other actions, or if another trigger to store the search result links occurs, such as a user requesting to store the search result links. If a user is no longer accessing the search results links or a storage trigger occurs, then the process passes to block 912. Block 912 depicts storing the reordered record of user selections of search result links according to the search terms and time period. Next, block 914 illustrates updating the list of available search result history reports with the search query terms, date, time and other parameters used in storing the reordered search result links, and the process ends.

Referring now to FIG. 10, a high level logic flowchart illustrates a process and program product for managing generation of search result history reports. In the example, the process starts at block 1000 and thereafter proceeds to block 1002. Block 1002 illustrates a determination whether a search result history report is requested with parameters. The parameters may include, for example, a user selection of an identifier, such as search query terms or a time, from a list of available search result history reports. In another example, the parameters may include a search query term or a selection of previous search query terms. If a search result history report is requested with parameters, then the process passes to block 1004. Block 1004 illustrates accessing the search result links applicable to the parameters from the reordered search result history database. Next, block 1006 depicts filtering and reordering the applicable search result links according to applicable criteria, such as applying predicted user interest from multiple sets of search results or removing previously unaccessed, or unpreferred links. Thereafter, block 1008 illustrates applying graphical or audible attributes to the applicable search result links to reflect previous user interaction or other information. Next, block 1010 depicts generating a selectable search history report for output of the applicable search result links, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method in a data processing system for ordering search results, comprising:
responsive to each user interaction of at least one user interaction with a plurality of search results to a plurality of separate network locations returned from a search request, reordering the plurality of search results to reflect a predicted user interest in the plurality of search results based on each user interaction;
storing the reordered plurality of search results; and
responsive to a request for the stored reordered plurality of search results, presenting said stored reordered plurality of search results in a separate interface

2. The method according to claim 1, wherein reordering the plurality of search results to reflect a predicted user interest in the plurality of search results based on each user interaction further comprises:
detecting a first amount of time of a first user interaction with a display interface comprising a first selection of the plurality of search results before detecting a second user interaction selecting a next selection of the plurality of search results;
detecting at least one common content element from the first selection of the plurality of search results; and
predicting user interest in the at least one common content element based on the first amount of time.

3. The method according to claim 1, wherein storing the reordered plurality of search results further comprises:
storing the reordered plurality of search results in a database according to a particular search query term triggering an initial search query for said plurality of search results with a plurality of separate sets of search results each specified according to a separate search query term; and
updating a selectable list of the plurality of separate sets of search results designated by each separate query term with the particular search query term.

4. The method according to claim 1, further comprising:
responsive to the request for the stored reordered plurality of search results, filtering said stored reordered plurality of search results to only present a selection of said stored reordered plurality of search results previously accessed in the at least one user interaction.

5. The method according to claim 1, further comprising:
responsive to the request for the stored rendered plurality of search results, adjusting at least one graphical attribute of said stored reordered plurality of search results for presentation to reflect at least one characteristic of the at least one user interaction.

6. A system for ordering search results, comprising:
a search engine for determining a plurality of search results to a plurality of separate network locations for at least one search term;
a search result reorganizer, responsive to each user interaction of at least one user interaction with a plurality of search results to a plurality of separate network locations returned from a search request, for reordering the plurality of search results to reflect a predicted user interest in the plurality of search results based on each user interaction;
the search result reorganizer for storing the reordered plurality of search results; and
the search result reorganizer, responsive to a request for the stored reordered plurality of search results, for presenting said stored reordered plurality of search results in a separate interface

7. The system according to claim 6, the search result reorganizer further comprising:
a database for storing the reordered plurality of search results according to a particular search query term triggering an initial search query for said plurality of search results with a plurality of separate sets of search results each specified according to a separate search query term.

8. The system according to claim 6, the search result reorganizer further comprising:
a search result reporter, responsive to the request for the stored reordered plurality of search results, for filtering said stored reordered plurality of search results to only present a selection of said stored reordered plurality of search results previously accessed in the at least one user interaction.

9. The system according to claim 6, the search result reorganizer further comprising:
a search result reporter, responsive to the request for the stored rendered plurality of search results, for adjusting at least one graphical attribute of said stored reordered plurality of search results for presentation to reflect at least one characteristic of the at least one user interaction.

10. A program product comprising a storage-type computer-usable medium including a computer-readable program for ordering search results, wherein the computer-readable program when executed on a computer causes the computer to:
responsive to each user interaction of at least one user interaction with a plurality of search results to a plurality of separate network locations returned from a search request, reorder the plurality of search results to reflect a predicted user interest in the plurality of search results based on each user interaction;
store the reordered plurality of search results; and
responsive to a request for the stored reordered plurality of search results, present said stored reordered plurality of search results in a separate interface

11. The program product according to claim 10, wherein the computer-readable program when executed on the computer further causes the computer to:
detect a first amount of time of a first user interaction with a display interface comprising a first selection of the plurality of search results before detecting a second user interaction selecting a next selection of the plurality of search results;
detect at least one common content element from the first selection of the plurality of search results; and
predict user interest in the at least one common content element based on the first amount of time.

12. The program product according to claim 10, wherein the computer-readable program when executed on the computer further causes the computer to:
store the reordered plurality of search results in a database according to a particular search query term triggering an initial search query for said plurality of search results with a plurality of separate sets of search results each specified according to a separate search query term; and
update a selectable list of the plurality of separate sets of search results designated by each separate query term with the particular search query term.

13. The program product according to claim 10, wherein the computer-readable program when executed on the computer further causes the computer to:
responsive to the request for the stored reordered plurality of search results, filter said stored reordered plurality of search results to only present a selection of said stored reordered plurality of search results previously accessed in the at least one user interaction.

14. The program product according to claim 10, wherein the computer-readable program when executed on the computer further causes the computer to:
responsive to the request for the stored rendered plurality of search results, adjust at least one graphical attribute of said stored reordered plurality of search results for presentation to reflect at least one characteristic of the at least one user interaction.
